(19) United States
(12) Patent Application Publication
(10) Pub. No.: US 2025/0167572 A1
(43) Pub. Date: May 22, 2025

(54) POWER SUPPLY DEVICE AND TERMINAL

(71) Applicant: AAC ACOUSTIC TECHNOLOGIES (SHENZHEN) CO., LTD., Shenzhen (CN)

(72) Inventors: Changyuan You, Shenzhen (CN); Hongyan Tao, Shenzhen (CN)

(21) Appl. No.: 18/633,568

(22) Filed: Apr. 12, 2024

Related U.S. Application Data
(63) Continuation of application No. PCT/CN2023/132223, filed on Nov. 17, 2023.

(51) Int. Cl. H02J 7/00; G02B 27/01

(52) U.S. Cl. CPC H02J 7/0063; G02B 27/0176; H02J 7/0048; G02B 2027/0178

(57) ABSTRACT

A power supply device and a terminal are provided. The power supply device includes a battery module and at least one optical display module, the battery module is electrically connected to the at least one optical display module, the battery module is configured to supply electrical signals to the at least one optical display module, so that the battery module directly supplies power to the at least one optical display module, which reduces a length of a power supply circuit and further reduces a width of the power supply circuit.

### TECHNICAL FIELD

The present disclosure relates to the field of battery power supply technology, and in particular to a power supply device and a terminal.

### BACKGROUND

A battery power supply network of augmented reality (AR) glasses is composed of a battery module at a middle portion of a left temple arm of the AR glasses, a power management integrated circuit (PMIC) of a motherboard at a right temple arm of the AR glasses, and two optical display systems respectively disposed on the left temple arm of the AR glasses and the right temple arm of the AR glasses, in which electric power passes through the battery module to the PMIC of the motherboard, and is output to the two optical display systems through the PMIC of the motherboard, a power supply circuit thereof circles from the left to the right first and then circles from the right to the left second, resulting in a doubling of a length thereof.

### SUMMARY

Based on above, the present disclosure provides a power supply device and a terminal to solve a problem of a doubling of a length of a power supply circuit.

In a first aspect, the present disclosure provides the power supply device, including a battery module and at least one optical display module. The battery module is electrically connected to the at least one optical display module, and the battery module is configured to supply electrical signals to the at least one optical display module.

As an improvement, the power supply device further includes a module assembly. The battery module is electrically connected to the at least one optical display module through the module assembly. The module assembly is configured to detect the electrical signals supplied by the battery module.

As an improvement, the module assembly includes a battery gauge module assembly and a resistance module. An output end of the battery module is electrically connected to an input end of the resistance module and an input end of the battery gauge module assembly, an input end of the at least one optical display module is electrically connected to an output end of the resistance module and an output end of the battery gauge module assembly.

As an improvement, the power supply device further includes a motherboard module. The motherboard module is connected to the battery module. The battery module is further configured to supply the electrical signals to the motherboard module.

As an improvement, the power supply device further includes a module assembly. The motherboard module is connected to the battery module through the module assembly. The module assembly is configured to detect the electrical signals supplied by the battery module.

As an improvement, the module assembly includes a battery gauge module assembly and a resistance module. An output end of the battery module is electrically connected to an input end of the resistance module and an input end of the battery gauge module assembly, an input end of the motherboard module is electrically connected to an output end of the resistance module and an output end of the battery gauge module assembly.

As an improvement, the motherboard module is connected to the at least one optical display module.

As an improvement, the power supply device further includes a conversion module. The motherboard module is connected to the conversion module and the at least one optical display module.

As an improvement, at least two optical display modules are provided.

In a second aspect, the present disclosure provides the terminal, including the power supply device as foregoing.

Compared with the related art, the present disclosure provides the power supply device and the terminal, the power supply device includes the battery module and the at least one optical display module, the battery module is electrically connected to the at least one optical display module, the battery module is configured to supply the electrical signals to the at least one optical display module, so that the battery module directly supplies power to the at least one optical display module, which reduces the length of the power supply circuit and further reduces a width of the power supply circuit.

### BRIEF DESCRIPTION OF DRAWINGS

In order to more clearly illustrate technical solutions of embodiments of the present disclosure, drawings used in the embodiments are briefly described below, and obviously, the accompanying drawings in following description are merely some embodiments of the present disclosure, and those who skilled in the art may obtain other drawings based on the accompanying drawings without creative efforts.

FIG. 1 is a schematic diagram of augmented reality (AR) glasses according to the related art.

FIG. 2 is a schematic diagram of a circuit of the AR glasses according to the related art.

FIG. 3 is a schematic diagram of a power supply device according to a first embodiment of the present disclosure.

FIG. 4 is a schematic diagram of AR glasses according to one embodiment of the present disclosure.

FIG. 5 is a schematic diagram of the power supply device according to a second embodiment of the present disclosure.

FIG. 6 is a schematic diagram of the power supply device according to a third embodiment of the present disclosure.

FIG. 7 is a schematic diagram of a circuit of the AR glasses according to one embodiment of the present disclosure.

FIG. 8 is a schematic diagram of a terminal according to one embodiment of the present disclosure.

### DETAILED DESCRIPTION OF EMBODIMENTS

In order to better understand technical solutions of the present disclosure, embodiments of the present disclosure are described in detail below with reference to accompanying drawings.

It should be understood that the described embodiments are only a part but not all of the embodiments of the present disclosure. All other embodiments obtained by those who skilled in the art based on the embodiments of the present disclosure without creative efforts shall fall within a protection scope of the present disclosure.

Terminologies used in the embodiments of the present disclosure are for a purpose of describing particular embodiments only and is not intended to be limiting of the present disclosure. As used in the embodiments of the present disclosure and appended claims, singular forms “a”, “the”, and “cited” are also intended to include plural forms, unless context clearly indicates other meanings.

It should be understood that term “and/or” used herein is merely an association relationship describing associated objects, indicating that there may be three relationships, for example, A and/or B may indicate three cases that A exists alone, A and B exist, and B exists alone. In addition, a character “/” in the specification generally indicates an “or” relationship between the associated objects.

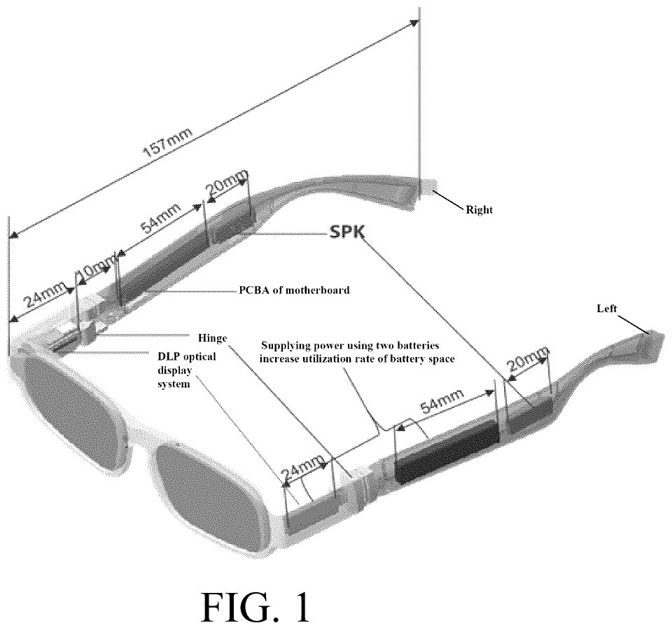

In the related art, FIG. 1 is a schematic diagram of augmented reality (AR) glasses according to the related art, as shown in FIG. 1, the AR glasses includes two digital light processing (DLP) optical display systems, two hinges, a battery module, a printed circuit board assembly (PCBA) of a motherboard, and two speakers. A length of the battery module is 52 mm, the battery module includes two batteries, the two batteries are disposed at a middle portion of a left temple arm of the AR glasses, and supplying power using two batteries increase a utilization rate of a battery space. The two DLP optical display systems include a left DLP optical display system and a right DLP optical display system, the two hinges include a left hinge and a right hinge, the two DLP optical display systems are respectively disposed at positions of the left temple arm and a right temple arm of the AR glasses close to a glasses frame, lengths of the two DLP optical display systems are both 24 mm. The left hinge is configured to connect the left DLP optical display system and the two batteries, the right hinge is configured to connect the right DLP optical display system and the PCBA of the motherboard, lengths of the left hinge and the right hinge are both 10 mm. The PCBA of the motherboard is disposed at a middle portion of the right temple arm of the AR glasses, a length of the PCBA of the motherboard is 54 mm. Lengths of the two speakers are both 20 mm.

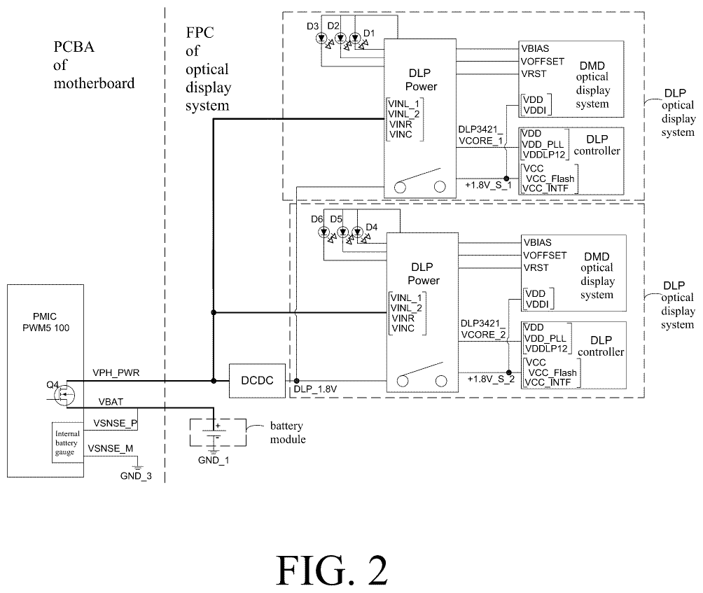

FIG. 2 is a schematic diagram of a circuit of the AR glasses according to the related art, based on FIG. 1 and as shown in FIG. 2, the PCBA of the motherboard includes a power management integrated circuit (PMIC) having a model of PWM5 100, the PMIC includes a transistor and an internal battery gauge, the internal battery gauge of the PMIC is configured to detect electric quantity. A battery module is connected to the PMIC of the PCBA of the motherboard, the PCBA of the motherboard is connected to a flexible printed circuit (FPC) of each of the DLP optical display systems. Thickened lines are used to represent a battery power supply network of the AR glasses. The battery power supply network needs to arrange a power supply circuit (a cable or a flexible printed circuit (FPC) wiring) from left to right, the battery module at the middle portion of the left temple arm of the AR glasses supplies power to the PCBA of the motherboard at the middle portion of the right temple arm of the AR glasses, and the PCBA of the motherboard at the middle portion of the right temple arm of the AR glasses respectively supplies the power to the two DLP optical display systems respectively disposed at the left temple arm and a right temple arm of the AR glasses. The power supply circuit circles from the left to the right first and then circles from the right to the left second, when the FPC wiring is used, a width thereof is doubled, and an increase of the width of the FPC wiring affects overlayers of the FBC and increases the number of FBC layers, thereby increasing thickness and hardness of the overlayers of the FBC, resulting in a doubling of a length of the power supply circuit.

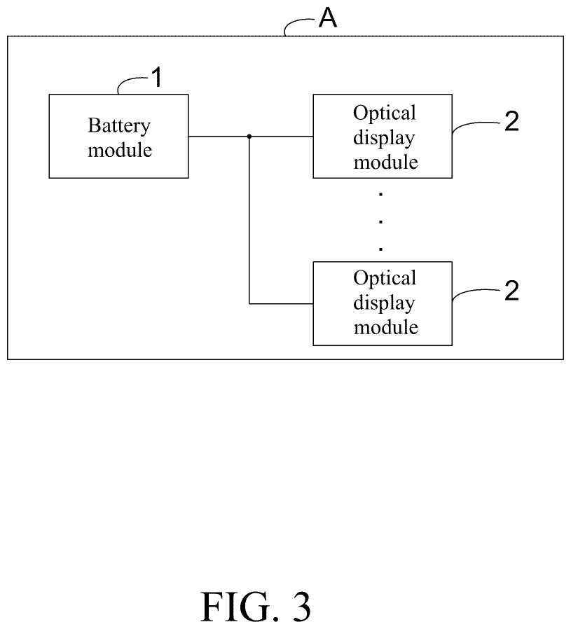

In order to reduce the length of the power supply circuit, FIG. 3 is a schematic diagram of a power supply device according to a first embodiment of the present disclosure, as shown in FIG. 3, the power supply device A includes a battery module 1 and at least one optical display module 2. The battery module 1 is electrically connected to the at least one optical display module 2, and the battery module 1 is configured to supply electrical signals to the at least one optical display module 2.

In the embodiments of the present disclosure, the electrical signals include a current signal and/or a voltage signal. The battery module 1 includes a battery. The at least one optical display module 2 includes an optical display system. The power supply device A includes at least two optical display modules 2, for example, there are two optical display modules 2. Electrical connection between modules may be implemented only by means of the FPC wiring, or the electrical connection between the modules may also be implemented only by means of the cable, there is no need that the battery module 1 transmits an electrical signal to a motherboard module, and then the motherboard module transmits the electrical signal to the optical display module 2, the battery module 1 directly supplies power to the at least one optical display module 2, thereby reducing the length and the width of the power supply circuit and further reducing a connection cost and line loss. Moreover, an FPC battery power supply network is formed, the FPC battery power supply network is composed of the battery module 1 and the at least one optical display module 2, the battery module 1 supplies power to the at least one optical display module 2, and the FPC battery power supply network is formed by adopting a segmented widening method, so that the number of FPC layers is reduced while the at least one optical display module is ensured to normally work.

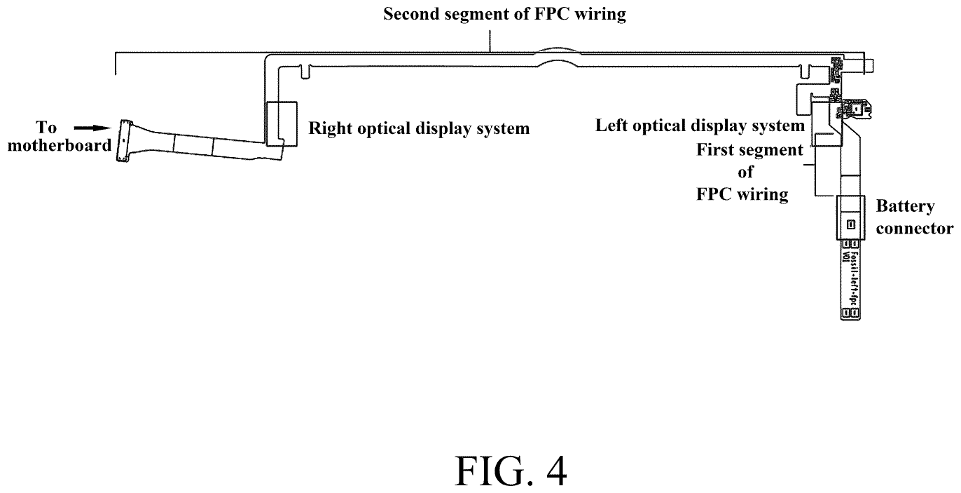

FIG. 4 is a schematic diagram of AR glasses according to one embodiment of the present disclosure, as shown in FIG. 4, the AR glasses include a battery, a motherboard, a left optical display system, and a right optical display system. The battery includes a battery connector. Electrical connection between the battery and the left optical display system is a first segment of FPC wiring, electrical connection between the battery to the right optical display system and the motherboard is a second segment of FPC wiring, a width of the first segment of FPC wiring and a width of the second segment of FPC wiring are different or are the same, in order to ensure that the left optical display system and the right optical display system are avoided from being affected when working with maximum brightness, generally, the width of the first segment of FPC wiring is greater than the width of the second segment of FPC wiring.

The embodiments of the present disclosure provide the power supply device A, the power supply device A includes the battery module 1 and the at least one optical display module 2, the battery module 1 is electrically connected to the at least one optical display module 2, the battery module 1 is configured to supply the electrical signals to the at least one optical display module 2, so that the battery module 1 directly supplies power to the at least one optical display module 2, which reduces the length of the power supply circuit and further reduces the width of the power supply circuit.

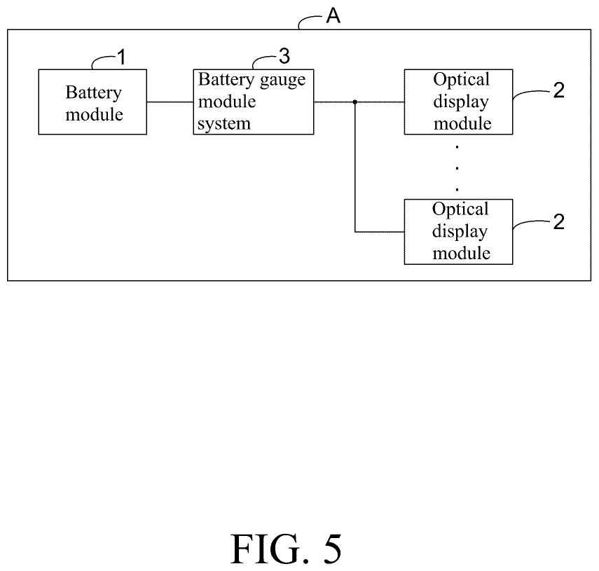

In one embodiment, FIG. 5 is a schematic diagram of the power supply device according to a second embodiment of the present disclosure, based on FIG. 3 and as shown in FIG. 5, the power supply device A further includes a module assembly 3. The battery module 1 is electrically connected to the at least one optical display module 2 through the module assembly 3. The module assembly 3 is configured to detect the electrical signals supplied by the battery module 1.

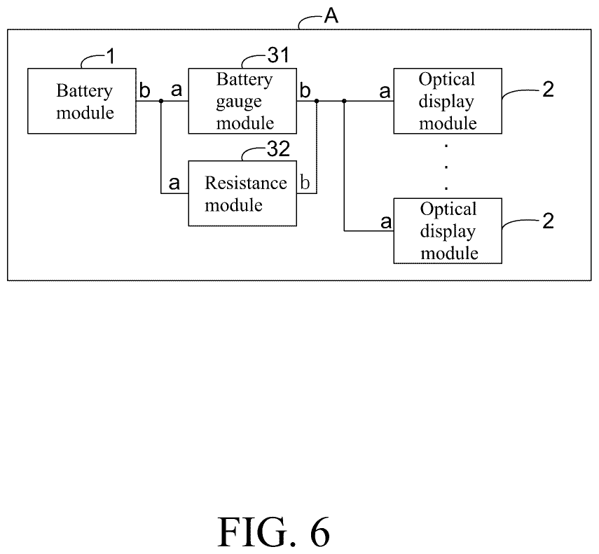

In the embodiments of the present disclosure, FIG. 6 is a schematic diagram of the power supply device according to a third embodiment of the present disclosure, based on FIG. 5 and as shown in FIG. 6, the module assembly 3 includes a battery gauge module assembly 31 and a resistance module 32. An output end b of the battery module 1 is electrically connected to an input end a of the resistance module 32 and an input end a of the battery gauge module assembly 31, an input end a of the at least one optical display module 2 is electrically connected to an output end b of the resistance module 32 and an output end b of the battery gauge module assembly 31.

In one embodiment, the power supply device A further includes a motherboard module 4. The motherboard module 4 is connected to the battery module 1. The battery module 1 is further configured to supply the electrical signals to the motherboard module 4.

As an improvement, the power supply device A includes a module assembly 3. The motherboard module 4 is connected to the battery module 1 through the module assembly 3. The module assembly 3 is configured to detect the electrical signals supplied by the battery module 1.

The module assembly 3 includes a battery gauge module assembly 31 and a resistance module 32. An output end of the battery module 1 is electrically connected to an input end of the resistance module 32 and an input end of the battery gauge module assembly 31, an input end of the motherboard module 4 is electrically connected to an output end of the resistance module 32 and an output end of the battery gauge module assembly 31. The FPC battery power supply network is composed of the battery module 1, the at least one optical display module 2, and/or the motherboard module 4, the battery module 1 supplies the power to the at least one optical display module 2 and/or the motherboard module 4. The motherboard 4 is further capable of connecting to the at least one optical display module 2, the power supply device further includes a conversion module 5. The motherboard module 4 is connected to the conversion module 5 and the at least one optical display module 2. For example, the conversion module 5 includes a DC to DC converter.

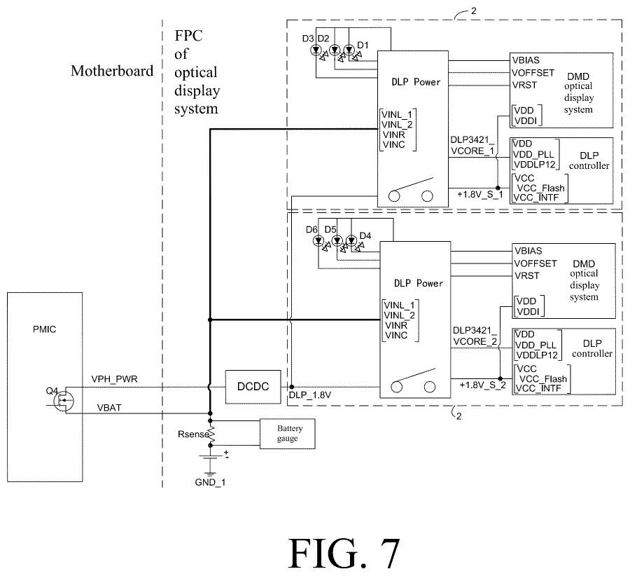

FIG. 7 is a schematic diagram of a circuit of the AR glasses according to one embodiment of the present disclosure. As shown in FIG. 7, the AR glasses include the battery, a resistor, a battery gauge, a motherboard, the two optical display modules 2, The motherboard includes a PMIC, the resistor is an Rsense resistor, each of the two optical display modules 2 includes a light emitting diode, a digital light processing (DLP) power supply, a digital micromirror device (DMD) optical display system, and a DLP controller, and thickened lines shown in FIG. 7 are power supply lines for connecting the battery to the two optical display modules 2. However, FIG. 7 only shows internal structures of the two optical display modules 2, and does not limit each of the two optical display modules 2.

As shown in table 1 below, the table 1 shows a parameter statistical table between the AR glasses shown in FIG. 2 and the AR glasses shown in FIG. 7.

TABLE 1

| | Impedance | Impedance | Width of | Width of |
|---|---|---|---|---|
| | of second | of first | second | first |
| | segment of | segment of | segment of | segment of |
| | FPC wiring | FPC wiring | FPC wiring | FPC wiring |
| FIG. 2 | <15.1 mohm | <87 mohm | 22.6 mm | 6.94 mm |
| FIG. 7 | <100 mohm | <30 mohm | 3.1 mm | 6 mm |

As shown in the table 1, electrical connection between the battery and the left optical display system is a first segment of FPC wiring, electrical connection between the battery to the right optical display system and the motherboard is a second segment of FPC wiring, and parameters thereof include an impedance of the second segment of FPC wiring, an impedance of the first segment of FPC wiring, a width of the second segment of FPC wiring, and a width of the first segment of FPC wiring. Based on FIG. 7, the impedance of the first segment of FPC wiring less than 30 milliohms (mohm) indicates that line loss of the width of the first segment of FPC wiring needs to be less than 30 mohm according to a power consumption of maximum brightness of a single optical display system and a power consumption of the motherboard; the impedance of the second segment of FPC wiring less than 100 mohm indicates that the battery directly supplies the power to the optical display systems, and line loss of the width of the second segment of FPC wiring needs to be less than 100 mohm according to the power consumption of the maximum brightness of the single optical display system and the power consumption of the motherboard; the width of the first segment of FPC wiring being 6 mm indicates that the width of the power supply line for connecting the battery and the left optical display system is 6 mm; and the width of the second segment of FPC wiring being 3.1 mm indicates that the width of the power supply line for connecting the battery and the right optical display system is 3.1 mm. Comparing the parameters, the impedance of the first segment of FPC wiring shown in FIG. 2 is greater than the impedance of the first segment of FPC wiring shown in FIG. 7, the width of the second segment of FPC wiring shown in FIG. 2 is greater than the width of the second segment of FPC wiring shown in FIG. 7, and the width of the first segment of FPC wiring shown in FIG. 2 is greater than the width of the first segment of FPC wiring shown in FIG. 7. A length of wiring shown in FIG. 7 is significantly less than a length of wiring shown in FIG. 2, so that the present disclosure supplies power to a load nearby based on a solution that that the power module directly supplies the power to the at least one optical display module and/or the motherboard module. the FPC battery power supply network is formed by adopting the segmented widening method, the at least one optical display module is avoided from being affected when working with the maximum brightness, and line loss thereof is controlled to be within a preset range, which reduces the length and the width of the power supply circuit, so that temple arm sections of the AR glasses shown in FIG. 4 may be wider than temple arm sections of the AR glasses shown in FIG. 1, a glasses frame section of the AR glasses shown in FIG. 4 may be smaller than a glasses frame section of the AR glasses shown in FIG. 1, thereby reducing the number of the FPC layers, and further reducing the thickness and the hardness of the overlayers of the FBC.

The embodiments of the present disclosure provide the power supply device A, the power supply device A includes the battery module 1 and the at least one optical display module 2, the battery module 1 is electrically connected to the at least one optical display module 2, the battery module 1 is configured to supply the electrical signals to the at least one optical display module 2, so that the battery module 1 directly supplies power to the at least one optical display module 2, which reduces the length of the power supply circuit and further reduces the width of the power supply circuit.

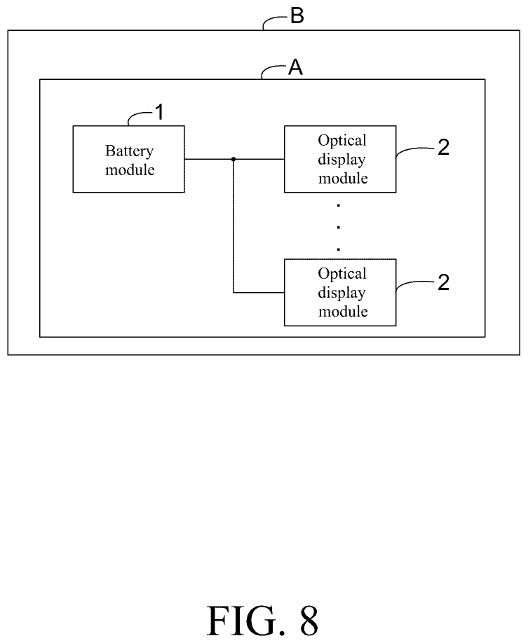

FIG. 8 is a schematic diagram of a terminal according to one embodiment of the present disclosure, as shown in FIG. 8, the terminal B includes the power supply device A, the power supply device A includes the battery module 1 and the at least one optical display module 2, the battery module 1 is electrically connected to the at least one optical display module 2, the battery module 1 is configured to supply the electrical signals to the at least one optical display module 2.

In the embodiments of the present disclosure, the terminal includes the AR glasses. For example, the terminal includes a left temple arm, a right temple arm, and a glasses frame, the glasses frame is connected to the left temple arm and the right temple arm. The terminal further includes the battery module 1 and two optical display module 2, the two optical display modules include a left optical display module 2 and a right optical display module 2. The battery module 1 and the left optical display module 2 are disposed at the left temple arm. The battery module 1 is connected to the left optical display system 2 through a first hinge, and the right optical display system 2 is disposed at the right temple arm. The battery module 1 is disposed at a middle portion of the left temple arm, the left optical display system 2 is disposed at a position of the left temple arm close to the glasses frame, and the right optical display system 2 is disposed at a position of the right temple arm close to the glasses frame. Electrical connection between modules may be implemented by means of the FPC wiring or the cable. When an FPC battery power supply network is formed, the FPC battery power supply network is composed of the battery module 1 and the two optical display modules 2, the battery module 1 supplies power to the at least one optical display module 2. A power supply line for connecting the battery module 1 to the left optical display module 2 is a first segment of FPC wiring, a power supply line for connecting the battery module 1 to the right optical display module 2 is a second segment of FPC wiring, the FPC battery power supply network is formed by adopting the segmented widening method, a width of the first segment of FPC wiring is greater than a width of the second segment of FPC wiring, so that temple arm sections of the terminal are correspondingly widened and a glasses frame section thereof is correspondingly reduced, a length and a width of a power supply circuit are reduced, and FPC layers are further reduced.

As an improvement, the power supply device A further includes a module assembly 3. The battery module 1 is electrically connected to the at least one optical display module 2 through the module assembly 3. The module assembly 3 is configured to detect the electrical signals supplied by the battery module 1.

As an improvement, the module assembly 3 includes a battery gauge module assembly 31 and a resistance module 32. An output end b of the battery module 1 is electrically connected to an input end a of the resistance module 32 and an input end a of the battery gauge module assembly 31, an input end a of the at least one optical display module 2 is electrically connected to an output end b of the resistance module 32 and an output end b of the battery gauge module assembly 31.

As an improvement, the power supply device further includes a motherboard module 4. The motherboard module 4 is connected to the battery module 1. The battery module 1 is further configured to supply the electrical signals to the motherboard module 4.

In the embodiments of the present disclosure, the motherboard module 4 is disposed at the right temple arm, the motherboard module 4 is connected to the right optical display module 2 through a second hinge. For example, the motherboard module 4 is disposed at a middle portion of the right temple arm.

As an improvement, the power supply device A further includes a module assembly 3. The motherboard module 4 is connected to the battery module 1 through the module assembly 3. The module assembly 3 is configured to detect the electrical signals supplied by the battery module 1.

As an improvement, the module assembly 3 includes a battery gauge module assembly 31 and a resistance module 32. An output end b of the battery module 1 is electrically connected to an input end a of the resistance module 32 and an input end a of the battery gauge module assembly 31, an input end a of the motherboard module 4 is electrically connected to an output end b of the resistance module 32 and an output end b of the battery gauge module assembly 31.

As an improvement, the motherboard module 4 is connected to the at least one optical display module 2.

As an improvement, the power supply device A further includes a conversion module 5. The motherboard module 4 is connected to the conversion module 5 and the at least one optical display module 2.

As an improvement, at least two optical display modules 2 are provided.

The embodiments of the present disclosure provide the terminal, including the power supply device. The power supply device A includes the battery module 1 and the at least one optical display module 2, the battery module 1 is electrically connected to the at least one optical display module 2, the battery module 1 is configured to supply the electrical signals to the at least one optical display module 2, so that the battery module 1 directly supplies power to the at least one optical display module 2, which reduces the length of the power supply circuit and further reduces the width of the power supply circuit.

The same or similar parts between the embodiments in the present specification may be referred to each other. In particular, for the terminal embodiment, since it is basically similar to the device embodiment, a description thereof is relatively simple, and for related parts, reference may be made to the description in the device embodiment. The above are only preferred embodiments of the present disclosure and are not intended to limit the present disclosure, and any modifications, equivalent replacements, improvements, etc. made within a spirit and a principle of the present disclosure shall fall within a protection scope of the present disclosure.

What is claimed is:

1. A power supply device, comprising:
a battery module; and
at least one optical display module;
wherein the battery module is electrically connected to the at least one optical display module, and the battery module is configured to supply electrical signals to the at least one optical display module.

2. The power supply device according to claim 1, further comprising:
a module assembly;
wherein the battery module is electrically connected to the at least one optical display module through the module assembly; and
the module assembly is configured to detect the electrical signals supplied by the battery module.

3. The power supply device according to claim 2, wherein the module assembly comprises a battery gauge module assembly and a resistance module; an output end of the battery module is electrically connected to an input end of the resistance module and an input end of the battery gauge module assembly; an input end of the at least one optical display module is electrically connected to an output end of the resistance module and an output end of the battery gauge module assembly.

4. The power supply device according to claim 1, further comprising:
a motherboard module;
wherein the motherboard module is connected to the battery module; and
the battery module is further configured to supply the electrical signals to the motherboard module.

5. The power supply device according to claim 4, further comprising:
a module assembly;
wherein the motherboard module is connected to the battery module through the module assembly; and
the module assembly is configured to detect the electrical signals supplied by the battery module.

6. The power supply device according to claim 5, wherein the module assembly comprises a battery gauge module assembly and a resistance module; an output end of the battery module is electrically connected to an input end of the resistance module and an input end of the battery gauge module assembly; an input end of the motherboard module is electrically connected to an output end of the resistance module and an output end of the battery gauge module assembly.

7. The power supply device according to claim 4, wherein the motherboard module is connected to the at least one optical display module.

8. The power supply device according to claim 7, further comprising:
a conversion module;
wherein the motherboard module is connected to the conversion module and the at least one optical display module.

9. The power supply device according to claim 1, wherein at least two optical display modules are provided.

10. A terminal, comprising:
the power supply device according to claim 1.
